(19) United States
(12) Patent Application Publication
(10) Pub. No.: US 2025/0192221 A1
(43) Pub. Date: Jun. 12, 2025

(54) ELECTRODE MATERIALS FOR ENERGY STORAGE DEVICES AND METHODS FOR MANUFACTURING SUCH DEVICES

(71) Applicant: Microvast, Inc., Stafford, TX (US)

(72) Inventors: Bryan Yonemoto, Lake Mary, FL (US); Yun Xu, Lake Mary, FL (US); Siyuan Gao, Lake Mary, FL (US); Huijie Guo, Huzhou (CN)

(21) Appl. No.: 18/536,688

(22) Filed: Dec. 12, 2023

(51) Int. Cl. H01M 10/0562; H01M 4/02; H01M 4/04; H01M 4/62; H01M 10/052

(52) U.S. Cl. CPC H01M 10/0562; H01M 4/0471; H01M 4/622; H01M 4/625; H01M 10/052; H01M 2004/021; H01M 2300/0071

(57) ABSTRACT

An energy storage device is provided in the present technology. The energy storage device includes one or more electrodes, each of the one or more electrodes including a solid state electrolyte material having a first average particle size less than 10 μm, wherein the solid state electrolyte material is ionically and electronically conductive, and an electrode active material having a second average particle size less than 30 μm, wherein the solid state electrolyte material and the electrode active material are mixed.

### TECHNICAL FIELD

The present disclosure relates to energy storage devices and, in particular, to electrodes for energy storage devices composed of solid state electrolyte materials and electrode active materials.

### BACKGROUND

Conductive solid state electrolyte materials are a critical component in advanced energy storage devices, such as electrochemical batteries now being used to power electrical grids, electrical vehicles, flying machines, and portable electronics. These solid state electrolyte materials offer several advantages over traditional liquid electrolytes and organic flammable electrolytes, including higher energy density, improved safety, and wider operational temperature ranges. For example, solid state electrolyte materials are non-flammable and less prone to leakage or thermal variation, making them safer for use in batteries. In addition, solid state electrolyte materials can store more energy in the same volume, thereby enabling higher energy density and longer lasting energy storage devices.

However, conductive solid state electrolyte materials also come with their own set of challenges. For example, many solid state electrolyte materials exhibit lower ionic and electrical conductivities in comparison to liquid electrolytes. It is hard to achieve a high enough conductivity by merely adopting solid state electrolyte materials in energy storage devices. Moreover, interfaces are reported to be existed between solid state electrolyte materials and other electrode materials in energy storage device, which further reduces the efficiency of charge transfer and overall battery device performance. Accordingly, there continues to be a need for ionically and electronically conductive solid state electrolyte materials for energy storage device applications.

### BRIEF DESCRIPTION OF THE DRAWINGS

FIGS. 1A, 1B, and 1C show a top down view of a pellet made of a solid state electrolyte material, a low magnification cross sectional view of the pellet, and a high magnification cross sectional view of the pellet, respectively, in accordance with one or more embodiments of the present technology.

FIG. 2 is a display diagram of various stages of a solid state electrolyte material sintering process configured in accordance with one or more embodiments of the present technology.

FIGS. 3A, 3B, and 3C show a top down view, a low magnification cross sectional view, and a high magnification cross sectional view, respectively, of the pellet described in FIGS. 1A-1C after a solid state electrolyte material sintering process in accordance with one or more embodiments of the present technology.

FIG. 4 shows x-ray diffraction (XRD) patterns of a solid state electrolyte material before and after a solid state electrolyte material sintering process configured in accordance with one or more embodiments of the present technology.

FIG. 5A depicts Electrochemical Impedance Spectroscopy (EIS) results of a solid state electrolyte material before a solid state electrolyte material sintering process, and FIG. 5B depicts EIS results after the solid state electrolyte material sintering process in accordance with one or more embodiments of the present technology.

FIG. 6 depicts electronic conductivities and ionic conductivities of a solid state electrolyte material before and after a solid state electrolyte material sintering process configured in accordance with one or more embodiments of the present technology.

FIG. 7 depicts a cycle life test result of a solid state battery including a solid state electrolyte material configured in accordance with one or more embodiments of the present technology.

FIG. 8 is a flow chart illustrating a method of processing an energy storage device electrode having a solid state electrolyte material and an electrode active material configured in accordance with one or more embodiments of the present technology.

FIG. 9 is a flow chart illustrating a method of processing a solid state electrolyte material in accordance with one or more embodiments of the present technology.

FIG. 10 is a schematic view of a system including an energy storage device configured in accordance with one or more embodiments of the present technology.

The drawings illustrate only example embodiments and are therefore not to be considered limiting in scope. The elements and features shown in the drawings are not necessarily to scale, emphasis instead being placed upon clearly illustrating the principles of the example embodiments. Additionally, certain dimensions or placements may be exaggerated to help visually convey such principles. In the drawings, the same reference numerals used in different embodiments designate like or corresponding, but not necessarily identical, elements.

### DETAILED DESCRIPTION

In solid state energy storage devices, the transport of ions carrying charges between an anode and a cathode is conducted via a solid electrolyte material, rather than a liquid electrolyte as in traditional lithium-ion batteries. The solid electrolyte material can be made of polymer, chalcogenide, composite, or ionic crystals instead of liquid phase materials that use dissolved anion/cation carrier to convey the transport ions. This solid electrolyte material adopted in energy storage device applications allows for the safe and efficient movement of ions therein, enabling the charge and discharge processes while eliminating risk of leakage and thermal issues associated with many conventional liquid electrolytes.

A solid state energy storage device includes various interfaces that may impact ion transport, electron conduction, and internal resistances. For example, a solid state battery may include anode-electrolyte interfaces, cathode-electrolyte interfaces, electrolyte-electrolyte interfaces, electrode-electrolyte interfaces, and interfaces with additional components of the energy storage device. To ensure efficient operation and desired performance for solid state energy storage devices, it is important to achieve solid, reliable contact at each of the above described interfaces. Some conventional technologies utilize a cathode electrode structure including an active material, a sulfur solid ionic conductor, and a conductive carbon material to ensure the ion and electron conduction in the solid state battery. However, using conductive carbons material and ionic conductor in a same electrode may introduce a competition in the active material particles. In addition, the particle sizes of the conductive carbon material and ionic conductor are dramatically different, which may lead to less efficient packing density of an electrode. As a result, there is a need for solid state electrolyte materials that can provide both high electrical conductivity and high ionic conductivity in solid state energy storage devices.

The present technology is directed to methods of fabricating electrode material for solid state energy storage devices. The disclosed methods include, for example, a first stage of forming ionically and electronically conductive solid state electrolyte material. In this stage, raw solid state electrolyte material can be synthesized using a rapid sintering process to improve its ionic and electronic conductivities. The sintered solid state electrolyte can be further ground to have an average particle size of, e.g., less than 10 μm. A second stage of the method is mixing the processed solid state electrolyte material powder with electrode active material powder and then grinding the mixed powder to achieve an average particle size of e.g., less than 30 μm. In this stage, the mixed solid state electrolyte material and electrode active material powders can be pressed into pellets or processed in a thin film for use with forming electrodes of the energy storage device. The disclosed method of the present technology avoids using any thermal treatments and is expected to prevent side reactions at the interface of the electrolyte material and active material.

### Ionically and Electronically Conductive Solid State Electrolyte Material

An initial stage of the present technology includes preparing solid state electrolyte materials that are ionically and electrically conductive. Various types of materials can be adopted here as suitable solid state electrolyte materials, including oxides, chalcogenides, polymers, polyanion materials, ionic salts, silicates, zeolites, molecular organic frameworks, covalent organic frameworks, or a combination thereof. In in particular embodiment, for example, a perovskite oxide composite having a ABO₃ structure can be a candidate in the present technology. For example, lithium lanthanum titanium oxide (LLTO) has a perovskite structure with a formula of Li₃ₓLa_{2/3-x}TiO₃ and x ranges from 0.01-0.66 can be selected as a raw solid state electrolyte material. In another specific embodiment, oxide composites having a sodium (Na) super lonic conductor (NASICON) structure, e.g., Li₁₊ₓAlₓTi₂₋ₓ(PO₄)₃ (LATP) with x ranging from 0.3 to 0.5 can be used as a raw solid state electrolyte material for processing. Here, the B site cation can be made of materials including Zirconium, Hafnium, Titanium, Tin, Gallium, Potassium, Magnesium, or Sodium, and the B′ site cation can be made of materials including Niobium, Tantalum, Molybdenum, or Tungsten. In some embodiments of the present technology, the solid state electrolyte material includes a transitional metal component, e.g., the B site cation of the ABO₃ perovskite oxide, that can be used to promote electrical conductivity. For example, the transitional metal component can be partially converted from a 4+ charge state to a 3+ charge state. In further embodiments, other suitable materials may be utilized.

In the present technology, it is preferable to fabricate solid state electrolyte materials having an ionic conductivity higher than 10⁻⁸ s/cm at 50° C. and an electrical conductivity higher than 10⁻⁸ s/cm at room temperature. In some examples, it is preferable to fabricate solid state electrolyte materials having an ionic conductivity higher than 10⁻⁵ s/cm at 50° C. and an electrical conductivity higher than 10⁻⁵ s/cm at room temperature. In some examples, it is preferable to fabricate solid state electrolyte materials having an ionic conductivity higher than 10⁻³ s/cm at 50° C. and an electrical conductivity higher than 10⁻³ s/cm at room temperature. In some examples, it is preferable to fabricate solid state electrolyte materials having an ionic conductivity higher than 10⁻¹ s/cm at 50° C. and an electrical conductivity higher than 10⁻¹ s/cm at room temperature. In some examples, it is preferable to fabricate solid state electrolyte materials having an ionic conductivity higher than 1 s/cm at 50° C. and an electrical conductivity higher than 1 s/cm at room temperature. In some examples, it is preferable to fabricate solid state electrolyte materials having an ionic conductivity higher than 2 s/cm at 50° C. and an electrical conductivity higher than 10 s/cm at room temperature.

The solid state electrolyte material of the present technology can have various forms (e.g., solid, crystalline, amorphous) and be capable of transporting conductive ions thru the material without using a liquid electrolyte. To achieve both ionically and electrically conductive at a cathode electrode, the solid state electrolyte can be selected from ceramic materials (e.g., lithium lanthanum titanium oxide (LLTO), lithium aluminum titanium phosphate (LATP), or lithium lanthanum zirconium oxide (LLZO)).

In some embodiments, raw solid state electrolyte materials can be (a) obtained from industrial chemical suppliers or (b) synthesized based on one or more raw materials. For example, the LLTO raw solid state electrolyte material can be synthesized from lithium carbonate, lanthanum oxide, and titanium dioxide ingredients. Since the chemical formula of LLTO is typically Li₃ₓLa₂₃₋ₓTiO₃ and x ranges from 0.01 to 0.66, corresponding molar amounts of lithium carbonate, lanthanum oxide, and titanium dioxide can be weighted and mixed to provide a desired composition of the solid state electrolyte material. The mixed compound powders can be further processed/mixed using, e.g., a ball mill tool to ensure a homogenous blend. In addition, in some embodiments, the compound powders can be pressed into pellets under a high pressure to form a desired shape for sintering, e.g., using a furnace sintering process at a temperature range of 1200° C. to 1400° C. for a certain duration to allow the reactants to undergo chemical reactions to form the LLTO compound. In some embodiments, the sintered LLTO pellets can be ground into powder for downstream processing.

The received/synthesized solid state electrolyte materials can be further processed to achieve an average particle size of, e.g., less than 10 μm and desired material phases. Raw LLTO material powder is described as a candidate solid state electrolyte material for use with method and systems configured in accordance with the present technology. The raw LLTO material can be processed via solid state synthesis, ball milling, hydrothermal process, solvothermal process, and/or other inorganic material preparation processes to grind the compound powder into the desired particle size. In some embodiments, for example, a ball mill machine comprises a rotating cylindrical drum filled with grinding balls and can be configured to contain the raw LLTO material. The drum can be mounted on a fixed surface and can rotate either continuously or intermittently. During milling, the grinding balls can impact and crush the LLTO material, thereby reducing it to a fine powder.

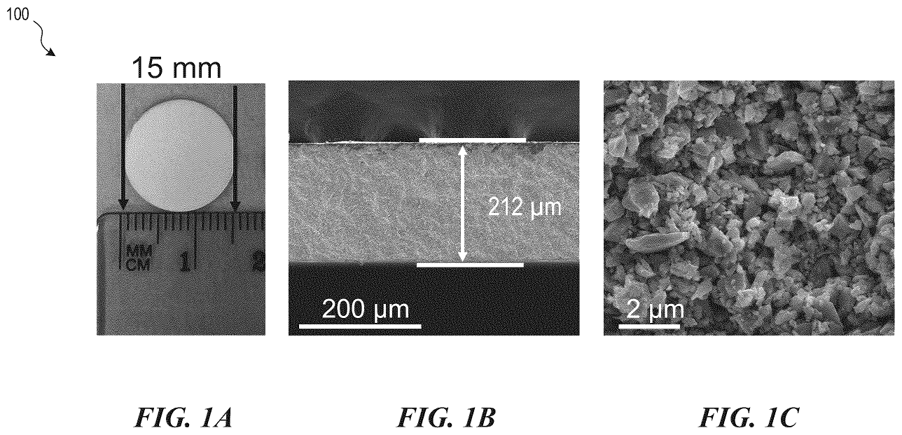

In a subsequent process, the processed LLTO material can be sent to a rapid sintering process, either in a loose powder phase or a compacted pellet configuration. FIGS. 1A, 1B, and 1C illustrate a top down view, a low magnification cross sectional view, and a high magnification cross sectional view, respectively, of a LLTO pellet 100 prepared for such a rapid sintering process. To fabricate the pellet shown in FIGS. 1A-1C, a desired amount of LLTO powder (e.g., 120 mg of LLTO powder) can be loaded into a pellet die for a pellet pressing process by applying pressure (e.g., 450 MPa) to the LLTO powder in the pellet die. In some other examples, a pressure up to 5 tons can be applied to the die using a hydraulic press (e.g., for up to 10 seconds) to form a uniform LLTO pellet. In this specific example, the pre-sintering LLTO pellet 100 has a diameter of about 15 mm and a thickness of about 212 μm. In other embodiments, however, the LLTO pellet 100 may have different dimensions.

The color of oxide composite materials can be influenced by factors such as impurities, grain size, presence of other compounds, and/or oxidation states of metal ions changes. In the case of LLTO, its primary color is white due to its composition and perovskite crystal structure. As shown in FIG. 1A, the LLTO pellet 100 carries over the white color of the received LLTO powder. The cross-sectional low magnification image of LLTO pellet 100 in FIG. 1B shows that the pellet is continuous without clear cracks, pores, nor secondary phase contrasts. The contrast shown on the low magnification cross sectional view of FIG. 1B appears to be uniform, indicating a uniform composition and density within the LLTO pellet 100. The high magnification image of the LLTO pellet 100 in FIG. 1C shows that there are vacancies disposed between adjacent LLTO grains and an average particle size of the LLTO pellet 100 ranges from 1 μm to 2 μm. In other embodiments, however, the particle size of the LLTO pellet 100 can vary.

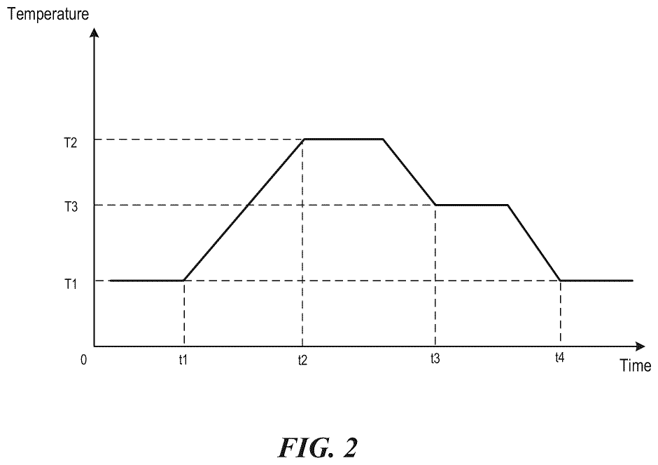

The present technology utilizes a rapid sintering process to further process the LLTO material, e.g., in a pellet shape or loose powder shape, to improve its electronic and ionic conductivities and make it applicable for solid state electrolyte applications. The rapid sintering process is usually operated quickly to ensure a minimal ion loss (e.g., Li ion of LLTO) and potentially less coarsening while still promoting densification of the material. FIG. 2, for example, is a display diagram of various stages of a solid state electrolyte material sintering process 200 configured in accordance with one or more embodiments of the present technology. In the present technology, various types of rapid sintering process can be adopted, including spark plasma sintering, laser sintering, joule heater sintering, infrared heat sintering, and/or flow assisted sintering.

The rapid sintering process adopted in the present technology can be identified by the duration of the total heating cycles shown in FIG. 2, including a loading stage (e.g., from 0 to t1), a heating stage (e.g., temperature ramping up from t1 to t2), a sintering stage (e.g., maintaining the same in the sintering temperature from t2 to t3), and a cooling temperature (e.g., from t3 to t4). During the loading stage, a sample can be loaded into the sintering equipment at a temperature T₁ lower than 3000° C., more preferably lower than 1000° C., and most preferably near room temperature. Then the temperature can be raised up until it hits the desired sintering temperature T₂, which can be in a range between 500° C. and 2000° C., and preferably between 1000° C. and 1500° C. The temperature ramping period t1 to t2 will be on an order of minutes, e.g., from 0 to 30 minutes, or more preferably from 0 to 2 minutes. When the sintering temperature T₂ is reached, the sample will be sintered at the sintering temperature T₂ from t2 to t3, which can last for less than 30 minutes. In some examples, it is preferable to configure the sintering temperature T₂ to be less than 20 minutes, less than 15 minutes, less than 10 minutes, or less than 5 minutes. In some other examples, it is more preferably to have the sintering temperature T₂ to be less than 2 minutes. In some examples, there may be multiple sintering stages conducted at various sintering temperatures and lasting for various durations. For example, the sample can be further sintered at a lower temperature T₃ from t3 to t4. This second sintering process may last for less than 30 minutes, or more preferably less than 2 minutes. Once the one or more sintering periods are completed, the active heating will cease, and the sample can be cooled back to the initial temperature T₁. As shown in FIG. 2, the sample cooling may last from t3 to t4, e.g., up to several minutes or several hours. In this example, the sample cooling rate can be controlled in accordance with an insulation level of rapid sintering tool and any quenching or active cooling accessories that are embedded in the rapid sintering tool.

In this example, a joule heating process can be used to rapid sintering the LLTO pellet 100. Joule heating process generally involves the generation of heat through the passage of an electric current through a conductive material. During a joule heating process, an electric current can be introduced into the sintering material using electrodes. The sintering materials (e.g., LLTO pellet 100) can serve as a resistive load through which the current passes. In this example, as the electric current flows through the LLTO pellet 100, it heats up rapidly due to joule heating. The temperature of the LLTO pellet 100 can increase to the point where it begins to sinter (e.g., the temperature T₂ at t2). In particular, the LLTO pellet 100 can be placed inside a strip (e.g., a strip of 11 cm by 1.5 cm AVCarb G300 soft graphite felt), which is then placed into a homemade Joule furnace. The heating chamber can be purged with argon gas. A DC power can be applied to the graphite felt and power can be increased (e.g., ramping from 0 amp to 21 amps in about 10 seconds). Then the LLTO pellet 100 can be kept in the heating chamber for additional time (e.g., 10 additional seconds) for the sintering, before the current gradually decrease back to zero (e.g., over another 10 second time period). The sintered LLTO pellet 300 can then be collected from the Joule heating furnace for downstream measurement and processes.

The rapid sintering process described in FIG. 2 is expected to provide an efficient way of preparing desired solid state electrolyte materials without using a long time process in a furnace. This rapid sintering process also offer benefits including a lower energy consumption in the sintering process, a reduction of coarsening of processed solid state electrolyte materials, and improved stoichiometry control of solid state electrolyte materials through shortening the sintering time to prevent additional material loss.

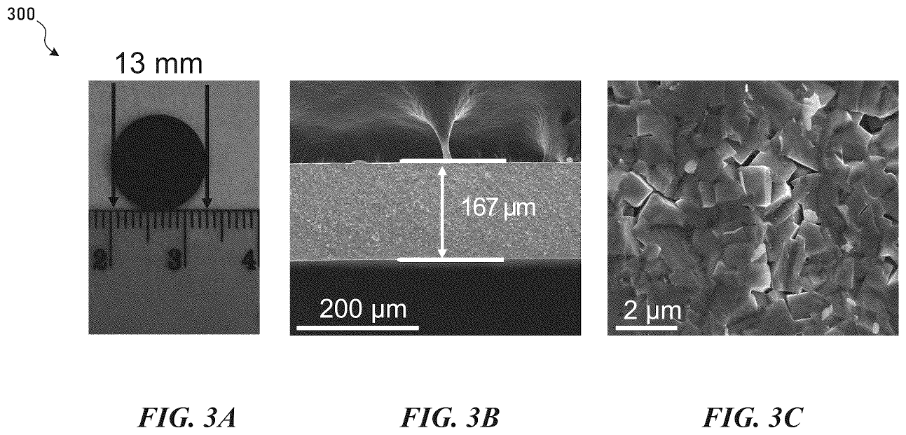

FIGS. 3A, 3B, and 3C show a top down view, a low magnification cross sectional view, and a high magnification cross sectional view, respectively, of the sintered LLTO pellet 300 after the rapid sintering process described in FIG. 2 in accordance with one or more embodiments of the present technology. Referring first to FIG. 3A, the diameter of the sintered LLTO pellet 300 is 13 mm, about 2 mm shrinkage from the pre-sintering diameter. Similar, the thickness of the sintered LLTO pellet 300 is also reduced (e.g., to 167 μm). It can be estimated that the rapid sintering process causes a total volume shrinkage (e.g., of up to 40%) on the LLTO pellet 100. In other embodiments, however, the diameter of the LLTO pellet 300 and/or the volume of shrinkage can vary.

In addition, the sintered LLTO pellet 300 shows a dark blue or a black color, indicating a B-site cation ion charge state change (e.g., Ti ions change from 4+ charge state to 3+ charge state with improved conductivity). In this example, the ratio of converted Ti ion having 3+ charge state is relevant to the rapid sintering process conditions, such as the sintering period, ambient atmosphere (e.g., in oxygen or nitrogen), etc. Further, it appears that the rapid sintering process causes the LLTO particles in the pellet to diffuse and bond together, resulting in a denser and solid structure. The high magnification SEM image FIG. 3C of the sintered LLTO material shows that there are reduced vacancies between the LLTO particles after the joule heating sintering process. LLTO grains can be found melted and merged together, which will benefit its ionic and electronic conductivities.

Following the rapid sintering process described in FIG. 2, the LLTO pellet can be crushed, ground, sieved, coated, sliced, polished and/or further processed by material handling equipment in order to prepare LLTO material having an average particle size less than 10 μm for use as a solid state electrolyte material in an energy storage device. In particular, the LLTO pellet 300 can be ground using a mortar and pestle to return to a powder form.

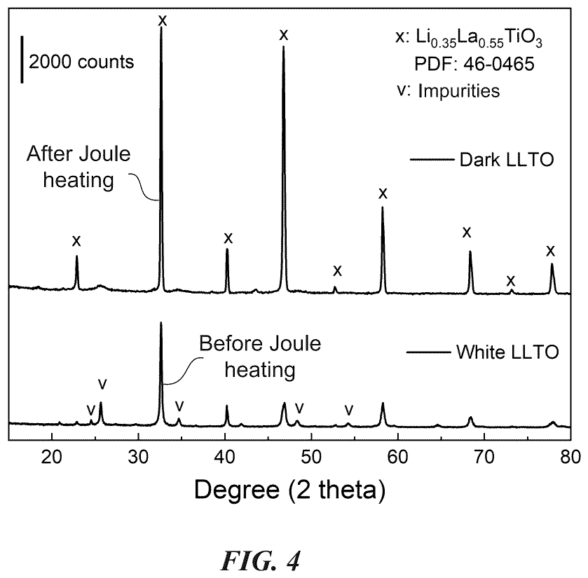

FIG. 4, for example, shows x-ray diffraction (XRD) patterns of the LLTO material both before and after the joule heating process in accordance with one or more embodiments of the present technology. In this particular embodiment, a copper X-ray tube generating Cu Kα1 line wavelength can be used to identify the crystalline phases, crystal structures, and crystallography of the solid state electrolyte material. As shown, the XRD pattern of sintered LLTO material includes multiple peaks that can be identified and matched well with the information recorded on Li_{0.35}La_{0.55}TiO₃ powder diffraction file (PDF) 46-0465. For example, the sintered LLTO material includes major peaks (labeled as “x”) located at 33°, 46°, and 590 of the XRD plotting. The peaks are indexed as (110), (200), and (211) crystal orientations, respectively. According to the LLTO PDF #46-0465, the sintered LLTO has a cubic structure. The pre-sintering LLTO material reveals additional impurities peaks (labeled as “v”) located at 250 and 26°, which can be indexed as a tetragonal phase of the LLTO material. The pre-sintered LLTO material XRD pattern also includes the cubic phase peaks, but with a much lower intensity.

Comparing the XRD patterns of LLTO material before and after the joule heating process, it can be found that the impurity phases have been substantially removed during the joule heating process. In addition, the intensities of corresponding XRD peaks are also largely increased, indicating an improved crystallinity of the cubic phase LLTO material. The XRD diffraction data can also be used for particle size distribution analysis. For example, average LLTO particle size in the pre-sintering LLTO pellet and sintered LLTO pellet can be calculated using Full width at half maximum (FWHM) of the diffraction peaks, X-ray wavelength, and Bragg angle information. As shown in below Table I, before the rapid sintering process in this particular embodiment, the LLTO pellet includes 10% of particles having a diameter less than 0.732 μm, 50% of particles having a diameter less than 1.08 μm, and 90% of particles having a diameter less than 2.02 μm. It can be found that the rapid sintering process (e.g., joule heating) can effectively condense the particles and form larger crystal grains therein. For example, the sintered LLTO pellet includes 10% of particles having a diameter less than 0.225 μm, 50% of particles having a diameter less than 3.29 μm, and 90% of particles having a diameter less than 10.1 μm. The average particle size of the LLTO material has been raised in 3× to 5× times after the rapid sintering process.

TABLE I
LLTO Particle Size Distribution (unit: μm)

| Sample Name | Dx (10) | Dx (50) | Dx (90) |
|---|---|---|---|
| LLTO_before | 0.732 | 1.08 | 2.02 |
| joule heating | | | |
| LLTO_after joule | 0.225 | 3.29 | 10.1 |
| heating | | | |

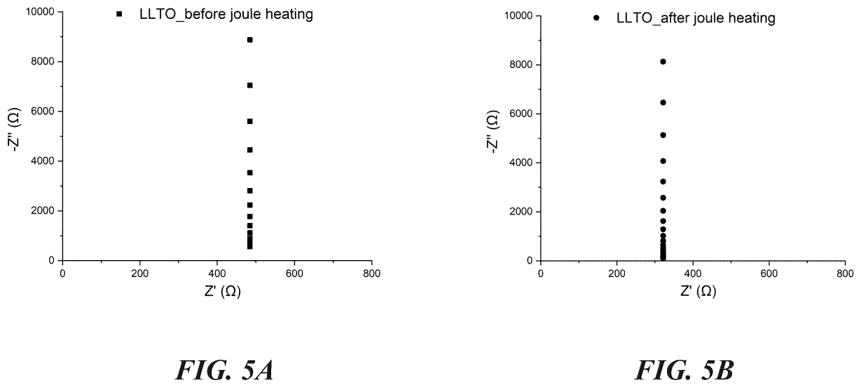

FIG. 5A shows EIS results of a solid state electrolyte material before a joule heating sintering process in accordance with one or more embodiments of the present technology, and FIG. 5B depicts EIS results after the solid state electrolyte material sintering process. In this example, a small amplitude alternating current signal (e.g., a 10 mV AC voltage) can be applied to a testing structure of “stainless steel-LLTO pellet-stainless steel” over a range of frequencies (e.g., ranging from 1 Hz to 1 MHz). As shown in FIG. 5A, the pre-sintered LLTO material has an impedance of 4950. After the joule heating, as shown in FIG. 5B, the impedance of the LLTO material is reduced to 3210. The estimated 35% impedance reduction in the LLTO pellet is contributed by the material densification, enhanced grain boundary connectivity, minimized grain boundary resistance, reduced impurity phases, and elimination of porosity/vacancy during the rapid sintering process illustrated in FIG. 2.

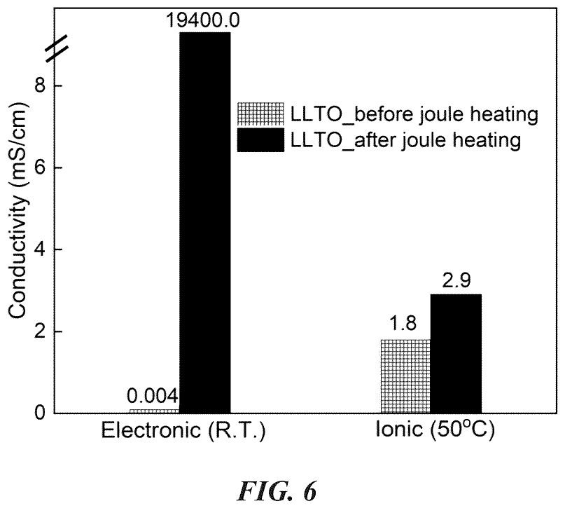

FIG. 6 depicts electronic conductivities and ionic conductivities of LLTO as solid state electrolyte material before and after the joule heating sintering process in accordance with one or more embodiments of the present technology. As shown, in the present embodiment, the electronic conductivity of the LLTO material at room temperature has been increased from 0.004 mS/cm to 19400 mS/cm. Further, the ionic conductivity of the LLTO material at 50° C. has been increased from 1.8 mS/cm to 2.9 mS/cm. The tremendously increased electronic conductivity and improved ionic conductivity in LLTO material echoes the impedance improvement shown in FIG. 5 and confirms that the rapid sintering process is important to fabricate solid state electrolyte materials both ionically and electrically conductive for energy storage device applications. In this example, the enhanced ionic and electrical conductivity of LLTO material is relevant to the Ti ion charge state conversion (e.g., from a 4+ charge state to a 3+ charge state). As described earlier, the rapid sintering process can partially convert the Ti ion to the 3+ charge state, which can lead to the creation of oxygen vacancies in LLTO's crystal lattice and improve the material conductivity.

In the present technology, the improved ionic and electrical conductivities of the solid state electrolyte material are expected to enable less competition at a cathode electrolyte interface through preventing a third phase conductive additive in the cathode electrode of an energy storage device. In addition, the improved ionic and electrical conductivities of the solid state electrolyte material can improve solid state energy storage device resistance as compared to conventional energy storage devices including unprocessed raw solid state electrolyte materials.

Mixing Solid State Electrolyte Material with Electrode Active Material

A second stage of the present technology includes mixing the solid state electrolyte material with an electrode active material and processing the mixed solid state electrolyte material and electrode active material for energy storage device electrode applications. In energy storage device applications, solid state electrolyte materials are responsible for conducting ions between the anode and cathode. They form conductive pathways within the energy storage device to allow ions to move while preventing a direct contact between the anode and cathode, which could short the energy storage device. In contrast, electrode active materials can be configured for storing and releasing electrical energy during energy storage device charging and discharging cycles. A primary function of electrode active materials is to undergo electrochemical reactions involving ion transitions during an energy storage device's operation.

Mixing the sintered solid state electrolyte material and the electrode active material two is expected to reduce the interface resistance by increasing the contact area therebetween. For example, in the mixed solid state electrolyte material and electrode active material, a higher flux area is available for Li-ions to transport from the solid state active material to the solid state electrolyte material. Furthermore, the sintered solid state electrolyte material exhibits Li-ion conductivity that is several orders of magnitude higher. Consequently, minimizing the diffusion distance of ions between the solid state active material and the solid state electrolyte is expected to further enhance the performance of the energy storage device. In the present technology, the electrode material (such as the electrode active material) is deliberately not sintered with the solid state electrolyte material to prevent any undesirable side reactions at the interface of these materials. Specifically, the rapid sintering process, as outlined in FIG. 2, is applied to the raw solid state electrolyte material before the second stage mixing process described above. This is done to enhance its ionic and electronic conductivity. The process flow described here is adaptable for the fabrication of various energy storage devices, including both traditional and solid state battery devices.

In the present technology, the electrode active material configured for anode electrode applications includes graphite, silicon, silica, alloys, metal oxides, lithium titanate, lithium metal materials, and a combination thereof. In addition, electrode active material configured for the cathode electrode applications includes lithium nickel manganese cobalt oxide, lithium nickel cobalt aluminum oxide, lithium iron phosphate, lithium manganese iron phosphate, lithium manganese phosphate, nickel manganese cobalt aluminum oxide, iron-based cathode materials, lithium manganese oxide, lithium nickel manganese oxide, and a combination thereof.

In the present technology, the solid state electrolyte material and cathode active material can be mixed in a mass ratio of 99:1 to 30:70. For example, the solid state electrolyte material and cathode active material can be mixed with a mass ratio of 50:50. In some other examples, the solid state electrolyte material and cathode active material can be mixed in a mass ratio greater than 70:30. For example, the solid state electrolyte material and cathode active material can be mixed with a mass ratio ranging from 95:5 to 50:50, from 90:10 to 70:30, or from 85:15 to 75:25.

In the above described second stage of the present technology, the solid state electrolyte material and electrode active material can be mixed in powders. For example, rapid sintered LLTO pellet can be ground into powders and then mixed with electrode active material for energy storage device electrode fabrication. In particular, the present technology configures the mixed solid state electrolyte material and electrode active material powders to a target average diameter less than 30 μm, and more preferably less than 15 μm. A ball milling tool, sieves or classifiers can be utilized here to process the mixed solid state electrolyte material and electrode active material powders and achieve the target powder diameter.

In the present technology, the mixed solid state electrolyte material and electrode active material can be further pressed into a pellet, which can be used as an electrode of an energy storage device. Moreover, the surface of electrode pellet can be polished, e.g., using fine abrasive sheets, to improve its solid-solid interfacial contact with other components of the energy storage device including current collectors or solid state separators.

In the present technology, binder material and/or conductive additives can be added to the mixed solid state electrolyte material and electrode active material to form an electrode of the energy storage device. Here, conductive additives can enhance the adhesion of electrode materials to the solid state electrolyte material, ensuring a better electrical connection. In addition, binder materials help hold the electrode active materials and conductive additives together, improving the mechanical stability of the electrode. The binder material also prevents cracking or delamination, which can occur due to volume changes of the electrode active materials during charging and discharging cycles of energy storage device operation. In this example, the binder material used for fabricating energy storage devices include polyvinylidene fluoride, polyethylene oxide, polytetrafluoroethylene, perfluoro sulfonic acid, carboxymethyl cellulose, styrene-butadiene rubber, or a combination thereof. The conductive additives used for fabricating energy storage devices include graphite, graphene, carbon nanotube, multi-walled carbon nanotube, vapor grown carbon fiber, or a combination thereof.

In one example and during the second stage of the present technology, the sintered LLTO pellet 300 can be further ground, e.g., using a mortar and pestle, to convert it back to powder. The LLTO solid state electrolyte powders can be further mixed with LiNi_{0.6}Mn_{0.2}Co_{0.2}O₂(NMC 622) powders in a mass ratio of 50:50. Thereafter, the mixture LLTO electrolyte powder and NMC 622 powder can be ground, e.g., using the ball milling tool and/or the mortar and pestle, until an average particle size of the mixed powders is less than 30 μm.

To compare electrochemical performance of electrode materials of the present technology and convention technologies, another counter sample is also prepared. For example, LLTO raw powders provided from industrial chemical suppliers was directly mixed with NMC 622 powders without the rapid sintering processing described in FIG. 2. The LLTO raw powder and NMC 622 powder are mixed in a mass ratio of 50:50 as well.

In the present technology, a polyetheretherketone (PEEK) battery test cell can be adopted for testing batteries and fuel cells performances including capacity, cycle life, and safety, etc. Herr, a solid state 15 mm PEEK test cell can be provided by vendor (e.g., a PEEK Split Cell Pressing Die Set manufactured by “Zhengzhou TCH Instrument Co” with a Model Number “EQ-PSC” was adopted for electrochemical testing described herein). In particular, 0.5 gram NMC/LLTO mixed loose powders are added to the cell fixture in an argon filled glovebox, then a compression die is inserted and gently rotated to form an initial cathode layer. After that a 0.12 gram solid state electrolyte separator layer lithium-gallium-phosphorous-sulfide (LGPS) is added to the cell fixture. The compression die is operated again to press the entire cell with a pressure of 2 MPa for 10 seconds. The compression die is then slowly removed and a lithium chip was placed inside the cell, followed by a thin piece of copper foil. The compression die is then operated again to tight the cell and the entire PEEK test set-up under a lite pressure. The PEEK battery test cell is then removed from glovebox and placed in the cell pressure fixture. The real test sample having sintered LLTO material and the counter sample having raw LLTO material are each prepared in corresponding PEEK battery test cells for the testing.

In the present technology, the PEEK battery test cell is then moved to an electrochemical workstation to collect electrochemical impedance spectroscopy (EIS) data. As shown in table II, the real sample and counter sample have a same test cell area of 1.76 cm² and a same cell thickness of 0.03 cm. However, the EIS test results show that the real sample including sintered LLTO material has a much lower ionic diffusion resistance based on the semi-circle diameter on the real axis. For example, the resistance value of the mixed sintered LLTO electrolyte and NMC 622 electrode active powders is 120 ohms. In contrast, the counter sample including raw LLTO electrolyte and NMC 622 electrode active has a much higher resistance of 1600 ohms.

TABLE II
EIS Test of Solid State Battery Cell

| | | | Ionic Diffusion |
|---|---|---|---|
| Sample Name | Area | Cell Thickness | Resistance |
| Real Sample | 1.76 cm² | 0.03 cm | 120 ohms |
| Counter Sample | 1.76 cm² | 0.03 cm | 1600 ohms |

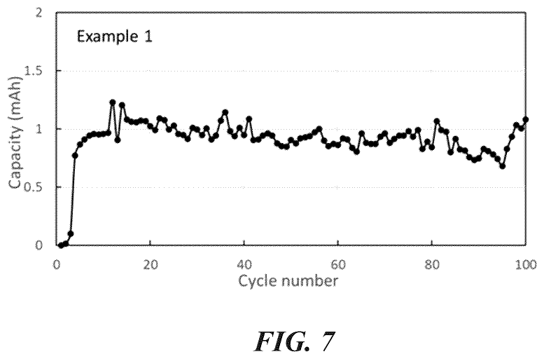

FIG. 7 depicts a cycle life test result of the above described PEEK battery test cell having the sintered LLTO electrolyte and NMC 622 electrode active powders. During the test, the battery test cell is placed in an oven (at 60° C.) and cycled from 2.7V to 4V with a 0.2 mA charge and a 0.1 mA discharge. As shown, the battery sample presents a high and stable capacity retention during the 100 cycles of test. The capacity-cycle number curve of the test cell reveals that sintered LLTO solid state electrolyte material brings in enhanced cyclic stability to the PEEK battery test cell.

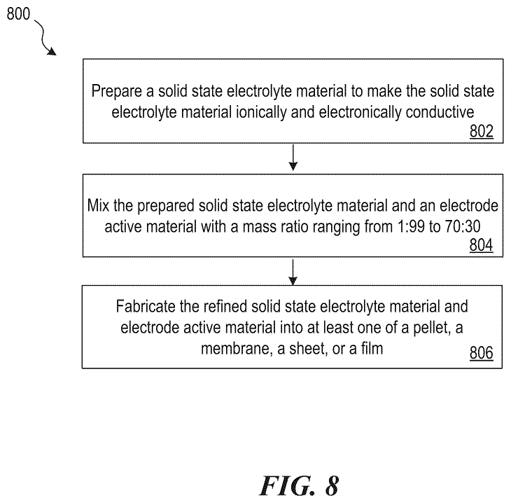

FIG. 8 is a flow chart illustrating a method 800 of processing an energy storage device electrode having a solid state electrolyte material and an electrode active material in accordance with one or more embodiments of the present technology. The method 800 includes preparing a solid state electrolyte material to make the solid state electrolyte material ionically and electronically conductive, at 802. For example, ionically and electronically conductive LLTO solid state electrolyte material can be processing through a rapid sintering process, as described in FIGS. 1 to 3. In addition, the method 800 includes mixing the prepared solid state electrolyte material and an electrode active material with a mass ratio ranging from 1:99 to 70:30, at 804. For example, the sintered LLTO solid state electrolyte powders can be further mixed with NMC 622 powders in a mass ratio of 50:50 to form electrode of energy storage device. Lastly, the method 800 includes fabricating the mixed solid state electrolyte material and electrode active material into at least one of a pellet, a membrane, a sheet, or a film, at 806. For example, the mixed LLTO powder and NMC 622 powder can be pressed into a pellet and installed into an energy storage device as an anode or a cathode. In other examples, the mixed LLTO powder and NMC 622 power can be coated as a membrane or a thin film on a substrate.

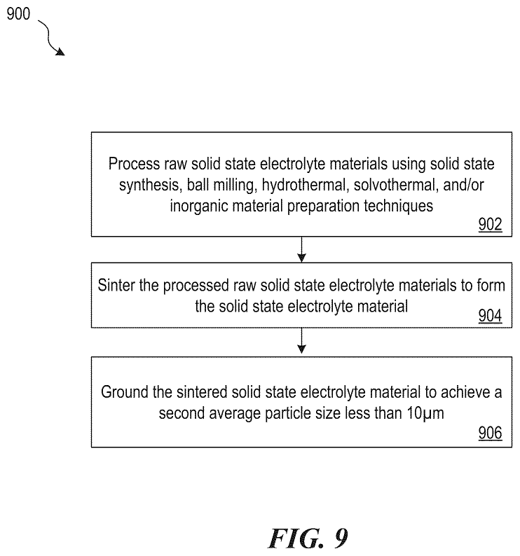

FIG. 9 is a flow chart illustrating a method 900 of processing a solid state electrolyte material in accordance with one or more embodiments of the present technology. The method 900 includes processing raw solid state electrolyte materials, at 902. For example, raw LLTO powders can be processed using solid state synthesis, ball milling, hydrothermal, solvothermal, and/or inorganic material preparation techniques. In particular, the raw LLTO powders can be processed by the ball milling tool to achieve a desired average particle size. Moreover, the method 900 includes sintering the processed raw solid state electrolyte materials to form the solid state electrolyte material, at 904. For example, a joule heating technique can be utilized to rapid sintering the raw LLTO powder to make it ionically and electronically conductive, as described in FIGS. 2 and 3. In addition, the method 900 may also include grinding the sintered solid state electrolyte material to achieve a second average particle size less than 10 μm, at 906. For example, after the rapid sintering process, the sintered LLTO pellet can be ground into loose powders. The LLTO powders grinding can be followed by the mortar and pestle processes to achieve an average particle size less than 10 μm. In particular, the LLTO pellet, once sintered, can be ground in an agate mortar for a minimum of 20 minutes. Subsequently, the ground LLTO sample can be sieved through a stainless steel mesh with a designated pore size. Finally, the sieved LLTO sample should be dried in a vacuum oven at 80° C. for no less than 12 hours.

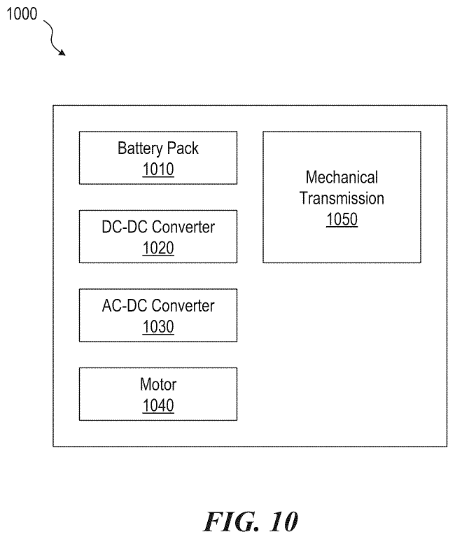

Any one of the energy storage devices described herein can be incorporated into any of a myriad of larger and/or more complex systems. FIG. 10, for example, is a representative example of such a system 1000. The system 1000 can include a battery pack 1010, a DC-DC converter 1020, an AC-DC converter 1030, a motor 1040, and/or other mechanical transmission 1050. The battery pack 1010 can include features generally similar to those of the ionically and electronically conductive solid state electrolyte materials described herein and can therefore include the mixed solid state electrolyte and electrode active materials described in accordance with the present technology. The system 1000 can perform any of a wide variety of functions, such as energy storage and power delivery, that requires high energy density and rechargeability. In addition, the battery pack 1010 of the system 1000 can be configured in series or parallel arrangements to achieve a desired voltage and capacity requirements for specific applications. The DC-DC converter 1020 can be coupled with the battery pack 1010 and configured for voltage level conversion for specific voltage outputs and voltage stabilization. In addition, the AC-DC converter 1030 can be also coupled with the battery pack 1010, and configured to convert alternating current from a main power source into direct current to charge the battery pack 1010. In the system 1000, the battery pack 1010, serving as a power source, can be coupled to a motor 1040 or any other mechanical transmission 1050 to deliver electrical energy in the forms of current. The components of the system 1000 can also include remote devices and any of a wide variety of computer-readable media and controlling processors.

Specific details of several embodiments of semiconductor devices, and associated systems and methods, are described Above. A person skilled in the relevant art will recognize that suitable stages of the methods described herein can be performed at the battery level or at the system level. Therefore, depending upon the context in which it is used, the materials used for the components of the energy storage devices can be deposited, for example, using chemical vapor deposition, physical vapor deposition, atomic layer deposition, plating, electroless plating, spin coating, and/or other suitable techniques. Similarly, materials for anode, separator, and cathodes of the all-electron energy devices can be designed, for example, using a first principle calculation and/or a hybrid DFT technique.

The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The functions described herein may be implemented in hardware, software executed by a processor, firmware, or any combination thereof. Other examples and implementations are within the scope of the disclosure and appended claims. Features implementing functions may also be physically located at various positions, including being distributed such that portions of functions are implemented at different physical locations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

It should be emphasized that many variations and modifications can be made to the above-described examples, the elements of which are to be understood as being among other acceptable examples. All such modifications and variations are intended to be included herein within the scope of this disclosure and protected by the following claims. Various other aspects, features, and advantages of the disclosure will be apparent through the detailed description of the disclosure and the drawings attached hereto. It is also to be understood that both the foregoing general description and the following detailed description are examples and are not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

I/We claim:

1. An energy storage device, comprising:
one or more electrodes, each of the one or more electrodes comprising:
a solid state electrolyte material having a first average particle size less than 10 μm, wherein the solid state electrolyte material is ionically and electronically conductive; and
an electrode active material having a second average particle size less than 30 μm, wherein the solid state electrolyte material and the electrode active material are mixed.

2. The energy storage device of claim 1 wherein the solid state electrolyte material comprises oxides, chalcogenides, polymers, polyanion materials, ionic salts, silicates, zeolites, molecular organic frameworks, and/or covalent organic frameworks.

3. The energy storage device of claim 1 wherein the solid state electrolyte material is an oxide with ABO₃ perovskite structure.

4. The energy storage device of claim 3 wherein B-site cations of the ABO₃ perovskite oxide have multiple charging states comprising a 3+ charge and a 4+ charge.

5. The energy storage device of claim 3 wherein the ABO₃ perovskite oxide comprises a four component oxide structure including a first B-site cation and a second B-site cation, and wherein:
a A-site cation of the ABO₃ perovskite oxide can be made of materials comprising lithium and strontium,
the first B-site cation can be made of materials comprising zirconium, hafnium, titanium, tin, gallium, potassium, magnesium, sodium, and
the second B-site cation can be made of materials comprising niobium, tantalum, molybdenum, and tungsten.

6. The energy storage device of claim 3 wherein the ABO₃ perovskite oxide has a chemical formula of Li₃ₓLa_{2/3-x}TiO₃, and x ranges from 0.01 to 0.66.

7. The energy storage device of claim 1 wherein the solid state electrolyte material has a sodium (Na) super lonic conductor (NASICON) structure, and wherein the solid state electrolyte material is composed of NASICON-type phosphates including Li₁₊ₓAlₓTi₂₋ₓ(PO₄)₃, x ranging from 0.3 to 0.5.

8. The energy storage device of claim 1 wherein the solid state electrolyte material has an ionic conductivity higher than 10⁻⁸ s/cm at 50° C. and an electrical conductivity higher than 10⁻⁸ s/cm at room temperature.

9. The energy storage device of claim 1 wherein the energy storage device comprises solid state batteries, lithium-ion batteries, lithium metal batteries, or lithium sulfur batteries.

10. The energy storage device of claim 1 wherein the one or more electrodes are configured as cathode electrodes or anode electrodes in the energy storage device.

11. The energy storage device of claim 10 wherein the electrode active material configured for the anode electrodes comprises graphite, silicon, silica, alloys, metal oxides, lithium titanate, and/or lithium metal materials, and wherein the electrode active material configured for the cathode electrodes comprises lithium nickel manganese cobalt oxide, lithium nickel cobalt aluminum oxide, lithium iron phosphate, lithium manganese iron phosphate, lithium manganese phosphate, nickel manganese cobalt aluminum oxide, iron-based cathode materials, lithium manganese oxide, and/or lithium nickel manganese oxide.

12. The energy storage device of claim 1 wherein each of the one or more electrodes further comprises binder materials including polyvinylidene fluoride, polyethylene oxide, polytetrafluoroethylene, perfluoro sulfonic acid, carboxymethyl cellulose, and/or styrene-butadiene rubber.

13. The energy storage device of claim 1 wherein each of the one or more electrodes further comprises conductive additive materials including graphite, graphene, carbon nanotube, multi-walled carbon nanotube, and/or vapor grown carbon fiber.

14. A method of forming an energy storage device, the method comprising:
preparing a solid state electrolyte material to make the solid state electrolyte material ionically and electronically conductive;
mixing the prepared solid state electrolyte material and an electrode active material with a mass ratio ranging from 1:99 to 70:30; and
fabricating the mixed solid state electrolyte material and electrode active material into at least one of a pellet, a membrane, a sheet, or a film.

15. The method of claim 14, further comprising: before fabricating the mixed solid state electrolyte and electrode active materials, grinding the mixed solid state electrolyte material and the electrode active material; and refining the ground solid state electrolyte material and electrode active material to achieve a third average particle size less than 30 μm.

16. The method of claim 14 wherein preparing the solid state electrolyte material comprises:
processing raw solid state electrolyte materials, and
sintering the processed raw solid state electrolyte materials to form the solid state electrolyte material.

17. The method of claim 16 wherein preparing the solid state electrolyte material further comprises grinding the sintered solid state electrolyte material to achieve a fourth average particle size less than 10 μm.

18. The method of claim 16 wherein the sintering of processed raw solid state electrolyte materials including an initial stage with a first temperature lower than 300° C., a temperature ramping up stage, a sintering stage with a second temperature ranging from 500° C. to 2000° C., and a cool down stage, wherein the temperature ramping up stage ranges from 0 to 30 minutes, and wherein the sintering stage is shorter than 30 minutes.

19. The method of claim 18 wherein the temperature ramping up stage of the sintering of processed raw solid state electrolyte materials can be conducted using technologies including spark plasma sintering, laser sintering, joule heater sintering, infrared heat sintering, or flow assisted sintering.

20. The method of claim 14 wherein preparing the solid state electrolyte material comprises preparing an ABO₃ perovskite oxide structure or preparing a sodium (Na) super lonic conductor (NASICON) structure oxide, wherein B-site cations of the ABO₃ perovskite oxide or the NASICON structure oxide have multiple charging states comprising a 3+ charge and a 4+ charge, and wherein the multiple charging states of B-site cations of the ABO₃ perovskite oxide or the NASICON structure oxide is formed by at least partially converting the B-site cations from a 4+ charge state to a 3+ charge state.
